(19) United States
(12) Patent Application Publication
(10) Pub. No.: US 2025/0287076 A1
(43) Pub. Date: Sep. 11, 2025

(54) AUTOMATICAL GENERATION OF VIDEO TEMPLATES

(71) Applicant: Lemon Inc., Grand Cayman (KY)

(72) Inventors: Sijie Zhu, Los Angeles, CA (US); Fan Chen, Los Angeles, CA (US); Longyin Wen, Los Angeles, CA (US)

(21) Appl. No.: 18/597,792

(22) Filed: Mar. 6, 2024

(51) Int. Cl. H04N 21/81; H04N 21/431

(52) U.S. Cl. CPC H04N 21/816; H04N 21/4318; H04N 21/8113

(57) ABSTRACT

The present disclosure describes techniques for automatically generating video templates based on images using a machine learning model. At least one image is received by the machine learning model. The machine learning model is trained to generate video templates based on input images. The video templates comprise editing components for generating or editing videos. A piece of music is received. A conditional embedding is generated by a first sub-model of the machine learning model based on a visual embedding indicative of the at least one image and a music embedding indicative of the piece of music. A representation of a video template is generated based on the conditional embedding by a second sub-model of the machine learning model. The video template is generated based on the representation of the video template.

### BACKGROUND

Video has emerged as a major modality of data across various applications, including social media, education, and entertainment. The predominant pipeline for video creation is based on various editing components. Techniques for creating videos using these editing components are desired.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for generating video templates based on images using a machine learning model in accordance with the present disclosure.

FIG. 2 shows an example process for training a machine learning model to generate video templates based on images in accordance with the present disclosure.

FIG. 3 shows an example diagram for generating a representation of a video template in accordance with the present disclosure.

FIGS. 4A-4B show an example process for generating video templates based on images using a machine learning model in accordance with the present disclosure.

FIG. 5 shows an example editing component applied on an image in accordance with the present disclosure.

FIG. 6 shows an example process for generating video templates based on images using a machine learning model in accordance with the present disclosure.

FIG. 7 shows an example process for training a machine learning model and generating video templates using the machine learning model in accordance with the present disclosure.

FIG. 8 shows an example process for preparing training data in accordance with the present disclosure.

FIG. 9 shows an example process for generating a representation of a particular video template in accordance with the present disclosure.

FIG. 10 shows an example process for generating video templates based on images using a machine learning model in accordance with the present disclosure.

FIG. 11 shows an example process for generating video templates based on images using a machine learning model in accordance with the present disclosure.

FIG. 12 shows an example computing device which may be used to perform any of the techniques disclosed herein.

### DETAILED DESCRIPTION OF ILLUSTRATIVE EMBODIMENTS

Many videos are created using video templates. Such video templates may comprise various editing components, such as a soundtrack, transitions, special effects, animation editing components, video effects, animation, transitions, filters, stickers, text, etc. To create a video using a video template, a user may apply the video template to a series of images. The resulting video may feature the various editing components applied to the series of images. Such video templates improve the content quality of creators while also enabling less experienced creators to produce content. However, it may be difficult or time consuming to generate high quality video templates. Many video templates are manually generated. While some techniques may exist that enable the automatic generation of video templates, such existing techniques are only able to generate simple, low-quality templates. Videos creating using such simple low-quality templates are also low quality. As such, improved techniques for automatically generating video templates are needed.

Described herein are improved techniques for automatically generating video templates based on images using a machine learning model. For example, if a user wants to generate a video using images, the techniques described herein enable the user to automatically generate a high quality video template that corresponds to the images. By enabling users to automatically generate high quality video templates based on images, the techniques described herein both improve the efficiency of the video creation process and improve the quality of the resulting videos.

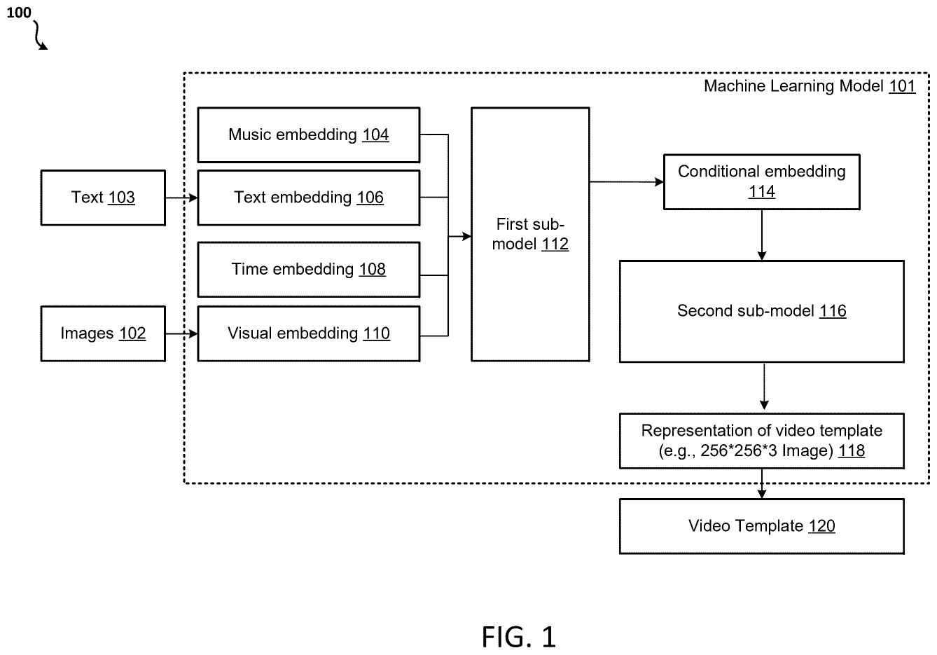

FIG. 1 shows an example system 100 for generating video templates based on images using a machine learning model 101. The machine learning model 101 may be trained to generate video templates based on input images. The machine learning model 101 may comprise a first sub-model 112 and a second sub-model 116. The first sub-model 112 may comprise, for example, a transformer model. The transformer model may comprise a neural network that learns context and meaning by tracking relationships in sequential data. The second sub-model 116 may comprise, for example, a latent diffusion model. The latent diffusion model may be configured to generate image from noise (e.g., low-resolution inputs). The second sub-model 116 may further comprise an encoder and/or a decoder.

The machine learning model 101 may receive, as input, images 102. The images 102 may comprise a plurality of images that a user wants to use to generate a video. For example, the user may want the plurality of images to be the frames of the video. The user may upload the images 102 via a user interface. The images 102 may be converted into one or more visual embeddings 110. The visual embedding(s) 110 may represent the features of the images 102. The images 102 may be converted into the visual embedding 110 using a contrastive language-image pre-training (CLIP) model. The CLIP model may be part of the first sub-model 112 and/or may be separate from the first sub-model 112.

In embodiments, the machine learning model 101 may additionally receive, as input, text 103. For example, the text 103 may comprise a natural language input that the user enters via a user interface (e.g., the same user interface via which the images 102 may be uploaded, or a different user interface). The text 103 may indicate a style and/or geographic region (e.g., country) associated with the video that the user wants to create. The text 103 may indicate any other features of the video that the user wants to create. The text 103 may be converted into a text embedding 106. The text embedding 106 may represent the features of the text 103. The text 103 may be converted into the text embedding 106 using a CLIP model. The CLIP model may be part of the first sub-model 112 and/or may be separate from the first sub-model 112.

A piece of music may be determined. The piece of music may be determined (e.g., recommended, selected) based on the images 102. Alternatively, the piece of music may be determined (e.g., recommended, selected) randomly or based on any other criteria, such as the style and/or the geographic region (e.g., country) associated with the video that the user wants to create, a holiday, etc. The piece of music may be converted into a music embedding 104. The music embedding 104 may represent the features of the piece of music. The piece of music may be converted into the music embedding 104 using any model that can convert music into embeddings (e.g., vectors, representations, etc.).

Timing information may be determined. The timing information may indicate a plurality time slots. The timing information may indicate, for each of the plurality of time slots, a start time, an end time, and/or a duration. The timing information may be determined based on one or more of the images 102, the piece of music, and/or the text 103. The timing information may be randomly determined. The timing information may be converted into a time embedding 108. The time embedding 108 may represent the features of the timing information. The timing embedding 108 may be generated, for example, by a multilayer perceptron (MLP). The MLP may be trained to generate the timing embedding 108 based on timing information.

The first sub-model 112 may receive, as input, the visual embedding 110, the text embedding 106, the music embedding 104, and the time embedding 108. The first sub-model 112 may generate a conditional embedding 114. The first sub-model 112 may generate the conditional embedding 114 based on one or more of the visual embedding 110, the text embedding 106, the music embedding 104, and the time embedding 108. For example, the transformer model of the first sub-model 112 may generate the conditional embedding 114 based on combining (e.g., aggregating) one or more of the visual embedding 110, the text embedding 106, the music embedding 104, and the time embedding 108 into a single embedding.

The second sub-model 116 may receive, as input, the conditional embedding 114. The second sub-model 116 may generate a representation 118. The representation 118 may be a representation of a video template. The second sub-model 116 may generate the representation 118 based on the conditional embedding 114. For example, the latent diffusion model of the second sub-model 116 may generate a latent space embedding from noise based on the conditional embedding 114. A decoder of the second sub-model 116 may decode the latent space embedding to generate the representation 118. The representation 118 may comprise, for example, a matrix having the same dimensions as an image. The representation 118 may comprise, for example, a 256×256×3 image matrix.

A video template 120 may be generated. The video template 120 may be generated based on the representation 118 of the video template. The video template 120 may comprise a plurality of editing components (e.g., video effects, animations, video transitions, filters, stickers, and/or text (e.g., text overlays)) corresponding to the plurality time slots. Each/each subset of the images 102 may correspond to a particular time slot of the plurality time slots. In embodiments, the plurality of editing components may be refined during post-processing process. The plurality of editing components may be refined by performing spatial adjustments on at least a subset of the plurality of editing components. Performing spatial adjustments may comprise computing the edge of each editing components to determine if the editing component is out of the edge of the video (e.g., too big for the video). If it is out of the video, the editing component may be resized to ensure it fits in the video. The plurality of editing components may be refined by performing temporal alignments based on the piece of music. Performing temporal alignment based on the piece of music may comprise determining whether the time ranges are aligned with the beat of the music and/or the lyric time stamps. If the time ranges are not aligned with the beat of the music and/or the lyric time stamps, the time ranges may be adjusted so that they align with the beat of the music and the lyric time stamps.

The video template 120 may be used to generate a video. Generating the video based on the video template 120 may comprise applying the video template 120 to the images 102. For example, generating the video based on the video template 120 may comprise applying the video template 120 comprising the refined editing components to the images 102. The generated video may feature the piece of music. The generated video may comprise the plurality of time slots. For each of the plurality of time slots in the video, the corresponding editing components may be applied to the corresponding image(s).

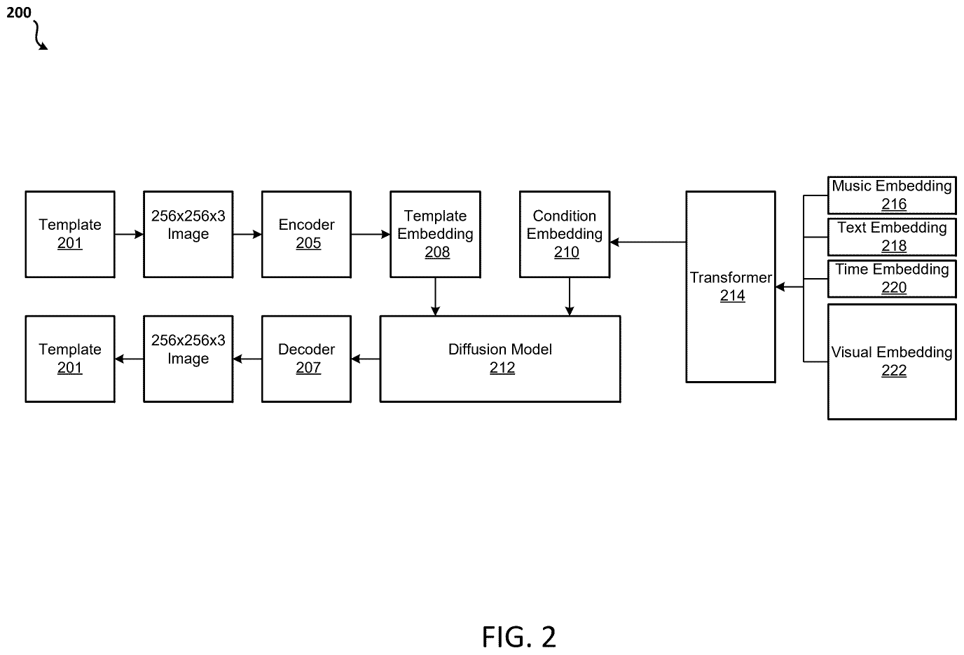

FIG. 2 shows an example process 200 for training the machine learning model 101 to generate video templates. As described above, the machine learning model 101 may comprise a first sub-model 112 and a second sub-model 116. The first sub-model 112 may comprise, for example, the transformer 214. The transformer 214 may comprise a neural network that learns context and thus meaning by tracking relationships in sequential data. The second sub-model 116 may comprise, for example, a latent diffusion model 212. The latent diffusion model 212 may be configured to generate image from noise (e.g., low-resolution inputs). The second sub-model 116 may further comprise an encoder 205 and a decoder 207.

The machine learning model 101 may be trained using pairs of training data. Each pair of training data may comprise a particular video template 201 (e.g., an existing video template) and particular conditional information corresponding to the particular video template 201. For each pair of training data, a representation of the video template 201 may be generated. The representation may comprise, for example, a matrix having the same dimensions as an image. The representation may comprise, for example, a 256×256×3 image matrix. The representation may be encodable and decodable by the second sub-model 116 of the machine learning model 101. For example, the representation may be encodable by the encoder 205 and decodable by the decoder 207. The encoder 205 may receive, as input, the representation of the video template 201. The encoder 205 may encode the representation of the video template 201 to a template embedding 208. The template embedding 208 may be a latent space embedding that is consumable by the latent diffusion model 212. The decoder 207 may decode output of the diffusion model 212 to the representation in the image format, for example 256×256×3 image matrix.

During the training process, the input and output templates of the second sub-model 116 may be the transformed 256×256×3 images corresponding to particular video templates, and the other inputs are conditional information associated with (e.g., comprised in) a corresponding particular video template in each pair of training data. The particular conditional information comprises one or more of visual information, music information, text information, and timing information associated with (e.g., comprised in) a corresponding particular video template. For example, the visual information (e.g., visual embedding 222) may comprise visual features comprised in the particular video template 201. The music information (e.g., music embedding 216) may indicate a piece of music comprised in the particular video template 201. The text information (e.g., text embedding 218) may indicate a style, geographic region (e.g., country), and/or any other features associated with the particular video template 201. The timing information (e.g., time embedding 220) may indicate a plurality of time slots as well as a start time, an end time, and/or a duration of each time slot in the particular video template 201. The first sub-model 112 (e.g., the transformer 214) may combine (e.g., aggregating) the visual embedding 222, the text embedding 218, the music embedding 216, and the time embedding 220 into the condition embedding 210.

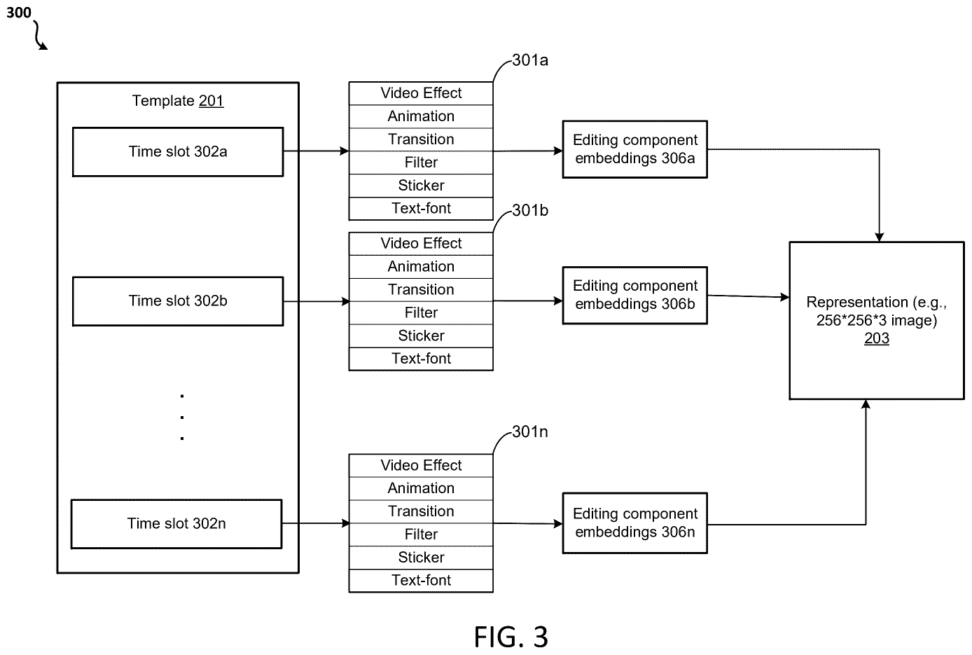

FIG. 3 shows an example diagram 300 for generating the representation 203 of the particular video template 201 that is encodable and decodable by the second sub-model 116 of the machine learning model 101. The particular video template 201 may comprise a plurality of time slots 302a-n. For each of the plurality of time slots 302a-n, a group of editing components may be determined. For example, a group of editing components 301a may be determined for the time slot 302a, a group of editing components 301b may be determined for the time slot 302b, and so on. Each group of editing components may indicate a video effect, an animation, a video transition, a filter, a sticker, and/or text (e.g., text overlays) associated with the corresponding time slot. If a particular time slot is not associated with one of the editing components (e.g., a time slot is not associated with a sticker), the value for that editing components may be “zero.” A plurality of groups of editing component embeddings 306a-n may be generated. Each of the groups of editing component embeddings 306a-n may correspond to a particular group of editing components 301a-n. For example, the group of editing component embeddings 306a may correspond to the group of editing components 301a, the group of editing component embeddings 306b may correspond to the group of editing components 301b, and so on. Each of the groups of editing component embeddings 306a-n may comprise, for example, a one hot embedding or a universal representation.

The representation 203 of the particular video template 201 may be generated based on arranging the plurality of groups of editing component 306a-n embeddings according to a sequence of the time slots. For example, a first row or column in the representation 203 may comprise the group of editing component embeddings 306a corresponding to the first time slot in the template 201 (e.g., the time slot 302a), a second row or column in the representation 203 may comprise the group of editing component embeddings 306b corresponding to the second time slot in the template 201 (e.g., the time slot 302b), and so on.

Referring back to FIG. 2, a condition embedding 210 may be generated by inputting a visual embedding 222 indicative of the visual information, a music embedding 216 indicative of the music information, a text embedding 218 indicative of the text information, and a time embedding 220 indicative of the timing information into the transformer 214. The transformer 214 may generate the condition embedding 210 based on combining (e.g., aggregating) one or more of the visual embedding 222, the music embedding 216, the text embedding 218, and the time embedding 220 into a single embedding. The condition embedding 210 may be a latent space embedding that is consumable by the latent diffusion model 212.

The latent diffusion model 212 may receive, as input, the template embedding 208 and the condition embedding 210. The latent diffusion model 212 may learn to associate the template embedding 208 with the condition embedding 210. The latent diffusion model 212 may output a latent space embedding corresponding to the template embedding 208. The decoder 207 may decode the output latent space embedding to reconstruct (regenerate) the representation (e.g., 256×256×3 image matrix) of the particular video template 201. The particular video template 201 may be reconstructed (regenerated) based on the reconstructed representation. This process may be repeated for each pair of training data (e.g., each existing video template and its corresponding conditional information). In this manner, the second sub-model 116 comprising the latent diffusion model 212 may learn to associate particular video templates with particular conditional information.

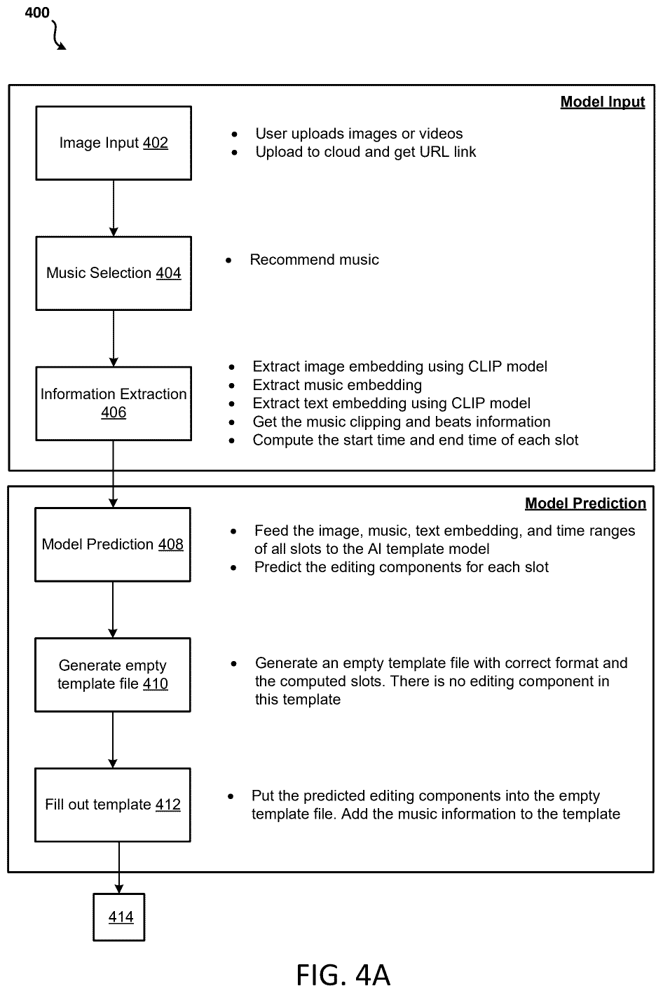

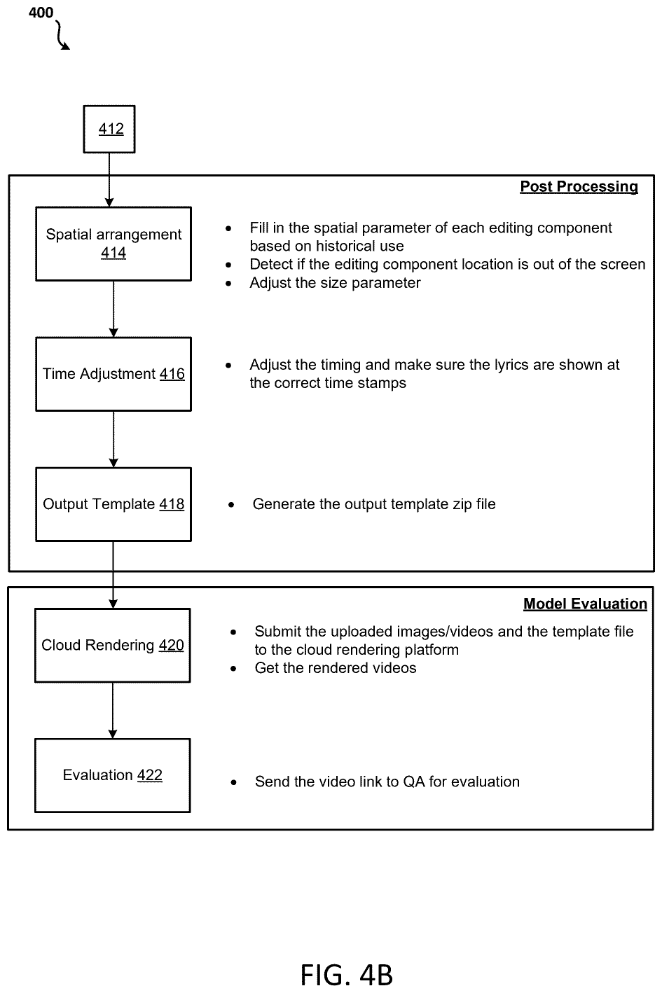

FIGS. 4A-4B show an example process 400 for generating video templates based on images using a machine learning model in accordance with the present disclosure. At 402, images and/or videos may be input. The images and/or videos may be input by a user. The images and/or videos may comprise a plurality of images or videos. For example, the user may want the plurality of images to be the frames of the video. The user may upload the images and/or videos, for example, to a cloud server. The images and/or videos may be associated with a location (e.g., a Uniform Resource Locator (URL)) in the cloud server. At 404, a piece of music may be selected. The piece of music may be selected based on the images and/or videos. Additionally, or alternatively, the piece of music may be selected based on any other criteria, such as the style and/or the geographic region (e.g., country) associated with the video that the user wants to create, a holiday, etc. The piece of music may be randomly selected.

At 406, information may be extracted. Information (e.g., features) may be extracted from the uploaded images and/or videos. The information may be extracted from the uploaded images and/or videos using a CLIP model. Information (e.g., features) may be extracted from the piece of music using any suitable model. Information indicating the beats and/or timing information associated with the piece of music may be determined. Timing information associated with the video template may be determined based on the beats and/or timing information associated with the piece of music. The timing information may indicate a plurality time slots associated with the video template. The timing information may indicate, for each of the plurality of time slots, a time range (e.g., a start time, an end time, and/or a duration). Information (e.g., features) may be extracted from text. The text may indicate a style and/or geographic region (e.g., country) associated with the video that the user wants to create. The text may indicate any other features of the video that the user wants to create. The information may be extracted from the text using a CLIP model.

At 408, the extracted information may be input into a machine learning model (e.g., the machine learning model 101). The information extracted from the uploaded images and/or videos may be input into the machine learning model 101. The information extracted from the piece of music may be input into the machine learning model 101. The time range (e.g., a start time, an end time, and/or a duration) information may be input into the machine learning model 101. The information (e.g., features) extracted from the text may be input into the machine learning model 101. The machine learning model 101 may predict one or more editing components (e.g., video effect, animations, video transitions, filters, stickers, and/or text (e.g., text overlays)) for each of the plurality of time slots based on the extracted information.

At 410, an empty template file may be generated. A format of the empty template file may correspond to the time range information. For example, the empty template file may comprise the plurality of time slots, each of the plurality of time slots having the time range determined at 406. At 412, the empty template file may be filled out (e.g., populated). The empty template file may be filled out using the predicted editing components. For example, the editing component(s) predicted for the first time slot may be used to fill out the first time slot in the empty template, the editing component(s) predicted for the second time slot may be used to fill out the second time slot in the empty template, and so on. The piece of music may be added to the template.

The predicted editing components may be refined. At 414, predicted editing components may be refined by performing spatial adjustments on at least a subset of the editing components. A spatial parameter of at least a subset of the editing components may be filled in based on historical use. For example, a spatial parameter for a particular editing component may be filled in based on historical use associated with the spatial parameter. Filling in a spatial parameter for a particular editing component may comprise detecting if the editing component is out of the screen (e.g., too big for the screen) or too small for the screen. If the editing component is too big for the screen or too small for the screen, a size parameter for the editing component may be adjusted so that the editing component is the appropriate size. At 416, the predicted editing components may be refined by performing temporal alignments based on the piece of music. The timing of the predicted editing components may be adjusted to ensure that they correspond to the correct time stamps. At 418, the video template may be output. The video template may comprise the refined editing components. Outputting the video template may comprise outputting a zip file containing the video template.

At 420, a video may be rendered. The video may be rendered based on the zip file containing the video template. The uploaded images and/or videos and the zip file containing the video template may be submitted to a video rendering platform (e.g., a cloud video rendering platform). The video rendering platform may retrieve the uploaded images and/or videos based on the URL. The video rendering platform may generate the video based on the retrieved images and/or videos and the zip file containing the video template. The video may be stored in the cloud server. The video may be associated with a location (e.g., a URL) in the cloud server. At 422, the video may be evaluated. A quality of the video may be evaluated. The quality of the video may be evaluated by sending the video URL to a quality assessment model or platform for evaluation.

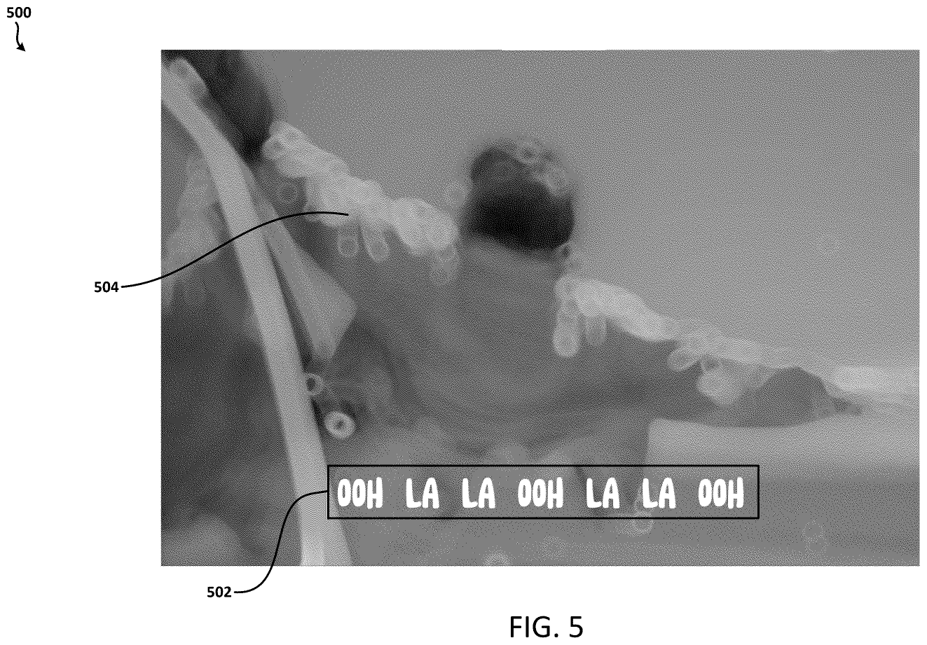

FIG. 5 shows an example image (e.g., video frame) 500 to which editing component(s) have been applied. As described above, a video template (e.g., the video template 120) may be used to generate a video. Generating the video based on the video template may comprise applying the video template to a plurality of the images. The generated video may feature the piece of music. The generated video may comprise the plurality of time slots. For each of the plurality of time slots in the video, one or more particular images from the plurality of images may be displayed. The video template may comprise one or more editing components corresponding to each of the plurality of time slots. In the example of FIG. 5, at least two editing components have been applied to the image 500. The first editing component 502 is text overlaid on the image 500. The text overlay may display the lyrics of the piece of music and/or any other text. The second editing component 504 is a video effect (e.g., bubbles) applied on the image 500. Each time slot (e.g., each image) in the video may correspond to one or more different editing components.

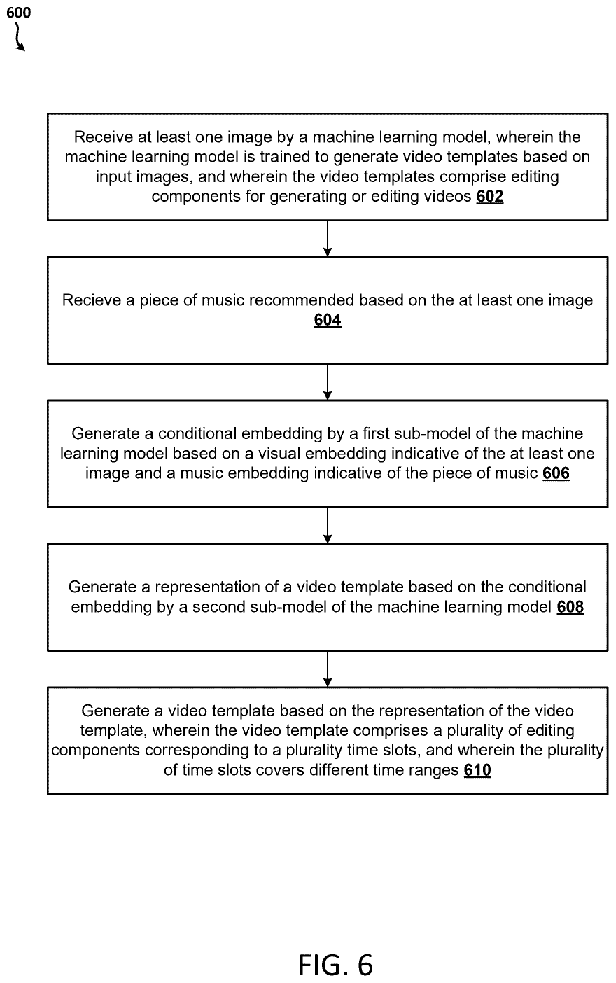

FIG. 6 illustrates an example process 600 for generating video templates based on images using a machine learning model. Although depicted as a sequence of operations in FIG. 6, those of ordinary skill in the art will appreciate that various embodiments may add, remove, reorder, or modify the depicted operations.

A machine learning model may be trained to generate video templates based on input images. The video templates comprise editing components for generating or editing videos. The machine learning model may comprise a first sub-model and a second sub-model. The first sub-model may comprise, for example, a transformer model. The second sub-model may comprise, for example, a latent diffusion model. At 602, at least one image may be received. The at least one image may be received by the machine learning model. The at least one image may comprise at least one image that a user wants to use to generate a video. For example, the user may want the at least one image to be the frame(s) of the video. The user may upload the at least one image via a user interface. The at least one image may be converted into at least one visual embedding. The visual embedding(s) may represent the features of at least one image. The at least one image may be converted into the visual embedding using a CLIP model. The CLIP model may be part of the first sub-model and/or may be separate from the first sub-model.

At 604, a piece of recommended music may be received. The piece of music may be determined (e.g., recommended, selected) based on the at least one image. Alternatively, the piece of music may be determined (e.g., recommended, selected) randomly or based on any other criteria, such as the style and/or the geographic region (e.g., country) associated with the video that the user wants to create, a holiday, etc. The piece of music may be converted into a music embedding. The music embedding may represent the features of the piece of music.

At 606, a conditional embedding may be generated. The conditional embedding may be generated by the first sub-model of the machine learning model (e.g., the first sub-model 112 of the machine learning model 101). The conditional embedding may be generated based at least on the visual embedding and the music embedding. For example, a transformer of the first sub-model may generate the conditional embedding based on combining (e.g., aggregating) at least the visual embedding and the music embedding into a single embedding.

At 608, a representation of a video template may be generated. The representation of the video template may be generated based on the conditional embedding. The second sub-model of the machine learning model (e.g., the second sub-model 116 of the machine learning model 101) may generate the representation of the video template based on the conditional embedding. For example, the latent diffusion model of the second sub-model may generate a latent space embedding from noise based on the conditional embedding. A decoder of the second sub-model may decode the latent space embedding to generate the representation of the video template. The representation may comprise, for example, a matrix having the same dimensions as an image. For example, the representation may comprise a 256×256×3 image matrix.

At 610, a video template may be generated. The video template may be generated based on the representation of the video template. The video template may comprise a plurality of editing components (e.g., video effects, animations, video transitions, filters, stickers, and/or text (e.g., text overlays)) corresponding to a plurality time slots. Each of the images may correspond to a particular time slot of the plurality time slots. Each of the plurality of time slots may cover a different time range (e.g., have a different start time, end time, and/or duration). The video template may be used to generate a video.

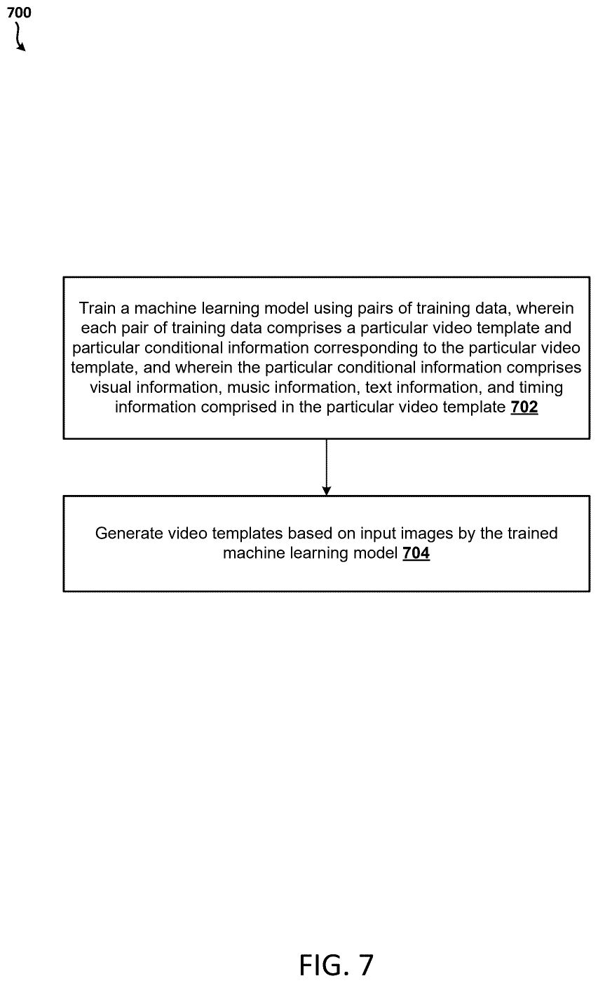

FIG. 7 illustrates an example process 700 for training a machine learning model and generating video templates using the machine learning model. Although depicted as a sequence of operations in FIG. 6, those of ordinary skill in the art will appreciate that various embodiments may add, remove, reorder, or modify the depicted operations.

At 702, a machine learning model may be trained. The machine learning model may be trained using pairs of training data. The machine learning model (e.g., the machine learning model 101) may comprise a first sub-model (e.g., the first sub-model 112 comprising a transformer 214) and a second sub-model (e.g., the second sub-model 116 comprising a latent diffusion model 212). Each pair of training data may comprise a particular video template and particular conditional information corresponding to the particular video template. The particular conditional information may comprise visual information, music information, text information, and timing information comprised in the particular video template. The visual information may comprise visual features associated with the particular video template. The music information may indicate a piece of music associated with the particular video template. The text information may indicate a style and/or geographic region (e.g., country) associated with the particular video template. The text information may indicate any other features associated with the particular video template. The timing information may indicate a plurality time slots associated with the particular video template. The timing information may indicate, for each of the plurality of time slots, a start time, an end time, and/or a duration.

For each pair of training data, a representation of the video template may be generated. The representation may comprise, for example, a matrix having the same dimensions as an image (e.g., 256×256×3 image matrix). An encoder of the machine learning model may encode the representation of the video template to a template embedding. The template embedding may be a latent space embedding that is consumable by a latent diffusion model (e.g., the latent diffusion model 212) of the second sub-model (e.g., the second sub-model 116). For each pair of training data, a condition embedding may be generated based on the particular conditional information by a transfer (e.g., the transformer 214 of the first sub-model 112). The condition embedding may be a latent space embedding that is consumable by the latent diffusion model.

The latent diffusion model may receive, as input, the template embedding and the condition embedding. The latent diffusion model may learn to associate the template embedding with the condition embedding. The latent diffusion model may output a latent space embedding corresponding to the template embedding. A decoder of the machine learning model may receive the output latent space embedding. The decoder may decode the output latent space embedding to reconstruct (regenerate) the representation (e.g., 256×256×3 image matrix) of the video template. The video template may be reconstructed (regenerated) based on the reconstructed representation. This process may be repeated for each pair of training data (e.g., each existing video template and its corresponding conditional information).

The trained machine learning model may be used to generate video templates based on images. A 704, video templates may be generated. The video template may be generated based on input images. The video template may be generated by the trained machine learning model.

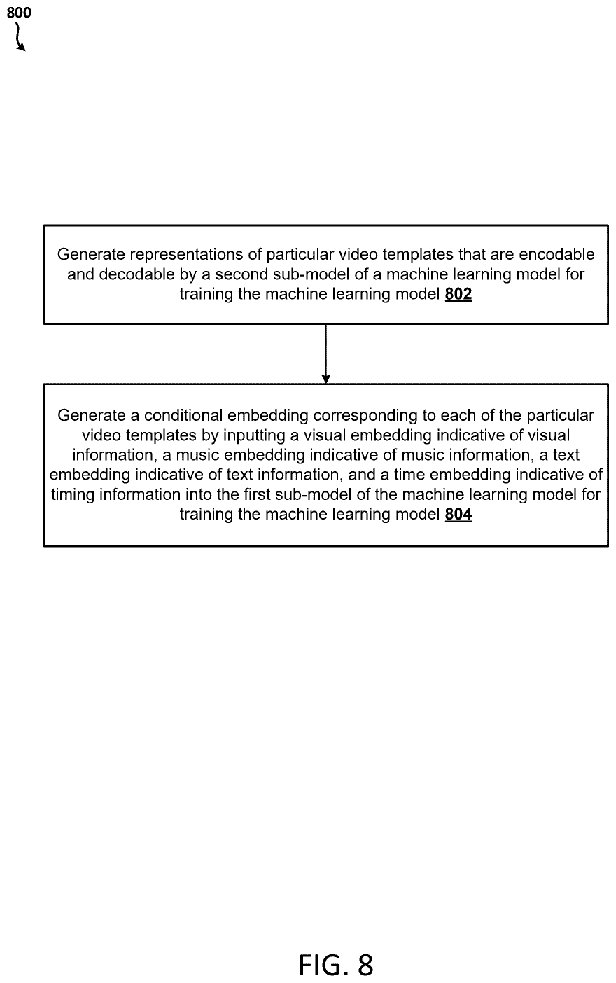

FIG. 8 illustrates an example process for preparing training data for training a machine learning model. Although depicted as a sequence of operations in FIG. 8, those of ordinary skill in the art will appreciate that various embodiments may add, remove, reorder, or modify the depicted operations.

A machine learning model may be trained. The machine learning model (e.g., the machine learning model 101 comprising the first sub-model 112 with a transformer 214 and the second sub-model 116 with the latent diffusion model 212) may be trained using pairs of training data. Each pair of training data may comprise a particular video template and particular conditional information corresponding to the particular video template. The particular conditional information may comprise visual information, music information, text information, and timing information comprised in the particular video template. The visual information may comprise visual features associated with the particular video template. The music information may indicate a piece of music associated with the particular video template. The text information may indicate a style and/or geographic region (e.g., country) associated with the particular video template. The text information may indicate any other features associated with the particular video template. The timing information may indicate a plurality time slots associated with the particular video template. The timing information may indicate, for each of the plurality of time slots, a start time, an end time, and/or a duration.

For each pair of training data, a representation of the video template may be generated. At 802, representations of particular video templates may be generated for training the machine learning model. The representations may be encodable and decodable by a second sub-model of a machine learning model (e.g., the second sub-model 116 of the machine learning model 101). The representations may comprise, for example, matrices having the same dimensions as an image. The representations may comprise, for example, 256×256×3 image matrices. An encoder may receive the representations of particular video templates. The encoder may encode each of the representations to a template embedding. The template embedding may be a latent space embedding that is consumable by a latent diffusion model (e.g., the latent diffusion model 212 of the second sub-model 116).

At 804, a conditional embedding corresponding to each of the particular video templates may be generated. The conditional embedding corresponding to each of the particular video templates may be generated by inputting a visual embedding indicative of the visual information, a music embedding indicative of the music information, a text embedding indicative of the text information, and a time embedding indicative of the timing information into a first sub-model (e.g., the first sub-model 112 comprising the transformer 214) of the machine learning model for training the machine learning model. The condition embedding may be a latent space embedding that is consumable by the latent diffusion model of a second sub-model (e.g., the latent diffusion model 212 of the second sub-model 116).

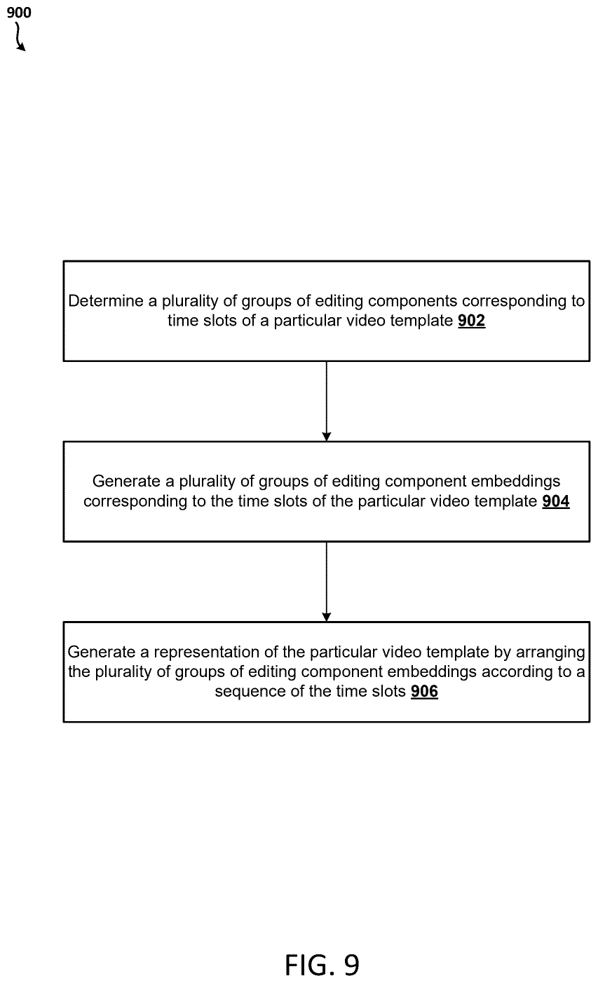

FIG. 9 illustrates an example process 900 for generating a representation of a particular video template. Although depicted as a sequence of operations in FIG. 9, those of ordinary skill in the art will appreciate that various embodiments may add, remove, reorder, or modify the depicted operations.

A representation of a video template may be generated for training a machine learning model. At 902, a plurality of groups of editing components in a particular video template may be determined. The plurality of groups of editing components may correspond to a plurality of time slots of the particular video template. For each of the time slots, a group of editing components may be determined. For example, a first group of editing components may be determined for the first time slot, a second group of editing components may be determined for the second time slot, and so on. Each group of editing components may indicate a video effect, an animation, a video transition, a filter, a sticker, and/or text (e.g., text overlays) associated with the corresponding time slot. If a particular time slot is not associated with any editing component, the editing component value corresponding to that particular time slot may be set as “zero.”

At 904, a plurality of groups of editing component embeddings may be generated. The plurality of groups of editing component embeddings may correspond to the time slots of the particular video template. Each of the plurality of groups of editing component embeddings may correspond to a particular group of editing components. For example, a first group of editing component embeddings may correspond to the first group of editing components, a second group of editing component embeddings may correspond to the second group of editing components, and so on. Each of the groups of editing component embeddings may comprise, for example, a one hot embedding or a universal representation. The editing component embeddings may be generated based on tokens corresponding to image(s) and guidance tokens. The image(s) may comprise content of raw materials and editing component(s) applied on the raw materials. The guidance tokens may provide prior knowledge of possible editing components. The tokens corresponding to the image(s) and the guidance tokens may be input into a different machine learning model (e.g., a machine learning model that is different from the machine learning model 101) for generating the editing component embeddings.

At 906, a representation of the particular video template may be generated. The representation may comprise, for example, a 256×256×3 image matrix. The representation of the particular video template may be generated by arranging the plurality of groups of editing component embeddings according to a sequence of the time slots. For example, a first row or column in the representation may comprise the first group of editing component embeddings corresponding to the first time slot, a second row or column in the representation may comprise the second group of editing component embeddings corresponding to the second time slot, and so on.

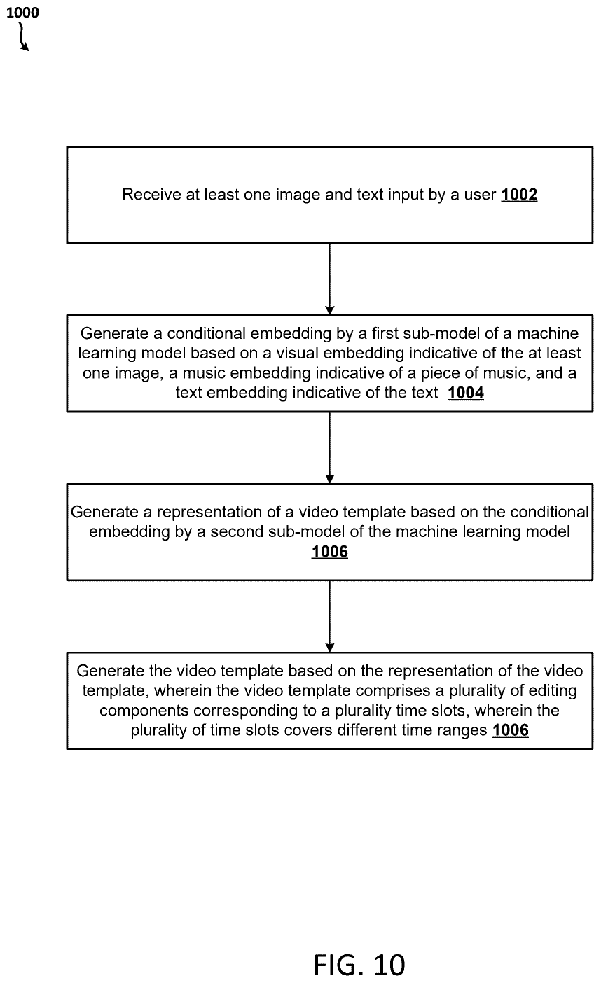

FIG. 10 illustrates an example process 1000 for generating video templates based on images using a machine learning model. Although depicted as a sequence of operations in FIG. 10, those of ordinary skill in the art will appreciate that various embodiments may add, remove, reorder, or modify the depicted operations.

A machine learning model may be trained to generate video templates based on input images. The video templates comprise editing components for generating or editing videos. The machine learning model (e.g., the machine learning model 101) may comprise a first sub-model (e.g., the first sub-model 112) and a second sub-model (e.g., the second sub-model 116). The first sub-model may comprise, for example, a transformer model. The second sub-model may comprise, for example, a latent diffusion model. At 1002, at least one image and text may be received. The at least one image may be received by the machine learning model. The at least one image may comprise at least one image that a user wants to use to generate a video. For example, the user may want the at least one image to be the frame(s) of the video. The user may upload the at least one image via a user interface. The at least one image may be converted into at least one visual embedding. The visual embedding(s) may represent the features of at least one image. The at least one image may be converted into the visual embedding using a CLIP model. The CLIP model may be part of the first sub-model and/or may be separate from the first sub-model.

The text may comprise a natural language input that the user enters or uploads via a user interface (e.g., the same user interface via which the images may be uploaded, or a different user interface). The text may indicate a style and/or geographic region (e.g., country) associated with the video that the user wants to create. The text may indicate any other features of the video that the user wants to create. The text may be converted into a text embedding. The text embedding may represent the features of the text. The text may be converted into the text embedding using a CLIP model. The CLIP model may be the same CLIP model that is used to generate the visual embedding. Alternatively, the CLIP model that us used to generate the text embedding may be a different CLIP model than the one that is used to generate the visual embedding.

At 1004, a conditional embedding may be generated. The conditional embedding may be generated by the first sub-model. The conditional embedding may be generated based at least on the visual embedding, the text embedding, and a music embedding associated with a piece of music. For example, the transformer model of the first sub-model may generate the conditional embedding based on combining (e.g., aggregating) at least the visual embedding, the text embedding, and the music embedding into a single embedding.

At 1006, a representation of a video template may be generated. The representation of the video template may be generated based on the conditional embedding. The second sub-model of the machine learning model may generate the representation of the video template based on the conditional embedding. For example, the latent diffusion model of the second sub-model may generate a latent space embedding from noise based on the conditional embedding. A decoder of the second sub-model may decode the latent space embedding to generate the representation. The representation may comprise, for example, a matrix having the same dimensions as an image. For example, the representation may comprise a 256×256×3 image matrix.

At 1008, a video template may be generated. The video template may be generated based on the representation of the video template. The video template may correspond to the text. The video template may comprise a plurality of editing components (e.g., video effects, animations, video transitions, filters, stickers, and/or text (e.g., text overlays)) corresponding to a plurality time slots. Each of the images may correspond to a particular time slot of the plurality time slots. Each of the plurality of time slots may cover a different time range (e.g., have a different start time, end time, and/or duration). The video template may be used to generate a video.

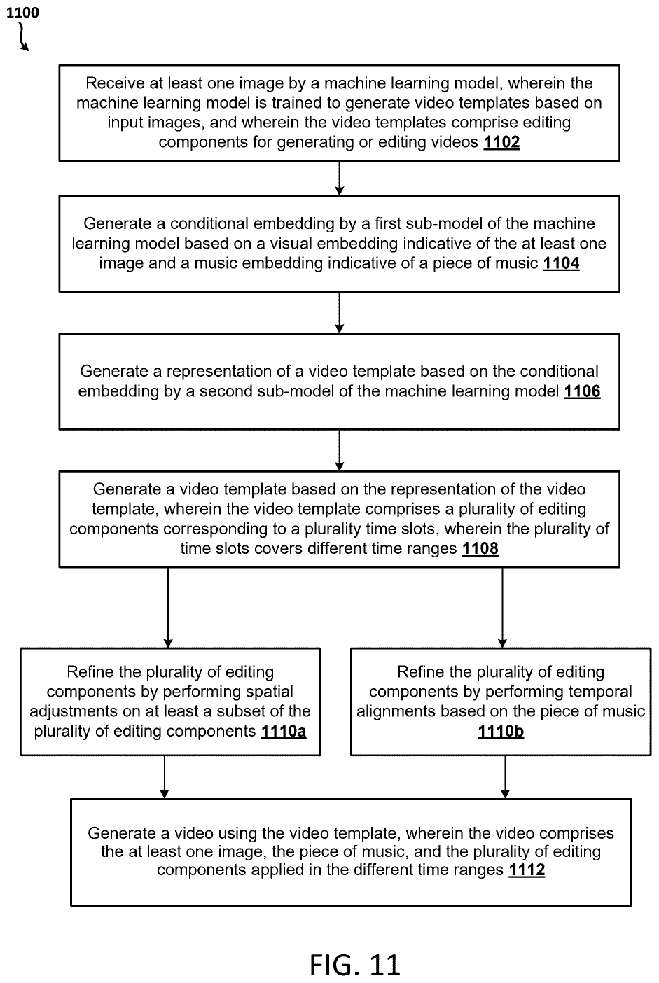

FIG. 11 illustrates an example process 1100 for generating video templates based on images using a machine learning model. Although depicted as a sequence of operations in FIG. 11, those of ordinary skill in the art will appreciate that various embodiments may add, remove, reorder, or modify the depicted operations.

A machine learning model may be trained to generate video templates based on input images. The video templates comprise editing components for generating or editing videos. The machine learning model (e.g., the machine learning model 101) may comprise a first sub-model (e.g., the first sub-model 112) and a second sub-model (e.g., the second sub-model 116). The first sub-model may comprise, for example, a transformer model. The second sub-model may comprise, for example, a latent diffusion model. At 1102, at least one image may be received. The at least one image may be received by the machine learning model. The at least one image may comprise at least one image that a user wants to use to generate a video. For example, the user may want the at least one image to be the frame(s) of the video. The user may upload the at least one image via a user interface. The at least one image may be converted into at least one visual embedding. The visual embedding(s) may represent the features of at least one image. The at least one image may be converted into the visual embedding using a CLIP model. The CLIP model may be part of the first sub-model and/or may be separate from the first sub-model.

At 1104, a conditional embedding may be generated. The conditional embedding may be generated by the first sub-model. The conditional embedding may be generated based at least on the visual embedding and a music embedding indicative of a piece of music. For example, the transformer model of the first sub-model may generate the conditional embedding based on combining (e.g., aggregating) at least the visual embedding and the music embedding into a single embedding.

At 1106, a representation of a video template may be generated. The representation of the video template may be generated based on the conditional embedding. The second sub-model of the machine learning model may generate the representation of the video template based on the conditional embedding. For example, the latent diffusion model of the second sub-model may generate a latent space embedding from noise based on the conditional embedding. A decoder of the second sub-model may decode the latent space embedding to generate the representation. The representation may comprise, for example, a matrix having the same dimensions as an image. For example, the representation may comprise a 256×256×3 image matrix.

At 1108, a video template may be generated. The video template may be generated based on the representation of the video template. The video template may comprise a plurality of editing components (e.g., video effects, animations, video transitions, filters, stickers, and/or text (e.g., text overlays)) corresponding to a plurality time slots. Each of the images may correspond to a particular time slot of the plurality time slots. Each of the plurality of time slots may cover a different time range (e.g., have a different start time, end time, and/or duration). The video template may be used to generate a video.

The plurality of editing components may be refined. At 1110a, the plurality of editing components may be refined by performing spatial adjustments on at least a subset of the plurality of editing components. A spatial parameter of at least a subset of the editing components may be filled in based on historical use. For example, a spatial parameter for a particular editing component may be filled in based on historical use associated with the spatial parameter. Filling in a spatial parameter for a particular editing component may comprise detecting if the editing component is out of the screen (e.g., too big for the screen) or too small for the screen. If the editing component is too big for the screen or too small for the screen, a size parameter for the editing component may be adjusted so that the editing component is the appropriate size. At 1110b, the plurality of editing components may be refined by performing temporal alignments based on the piece of music. The timing of the predicted editing components may be adjusted to ensure that they correspond to the correct time stamps.

At 1112, a video may be generated. The video may be generated based on the video template. Generating the video based on the video template 120 may comprise applying the video template to the images. For example, generating the video based on the video template may comprise applying the video template comprising the refined editing components to the images. The generated video may feature the piece of music. The generated video may comprise the plurality of time slots. For each of the plurality of time slots in the video, the corresponding editing components may be applied in the different time ranges to the corresponding image.

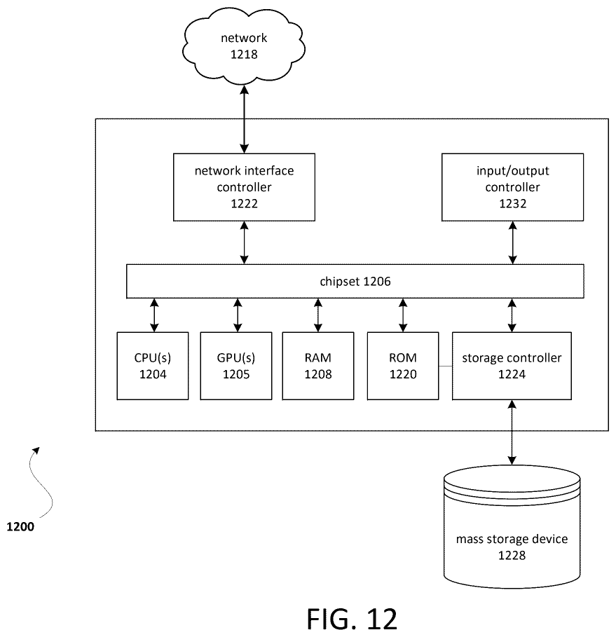

FIG. 12 illustrates a computing device that may be used in various aspects, such as the services, networks, sub-models, and/or devices depicted in FIGS. 1-2. With regard to FIGS. 1-2, any or all of the components may each be implemented by one or more instance of a computing device 1200 of FIG. 12. The computer architecture shown in FIG. 12 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1200 may include a baseboard, or “motherboard,” which is a printed circuit board to which a multitude of components or devices may be connected by way of a system bus or other electrical communication paths. One or more central processing units (CPUs) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1205. The GPU(s) 1205 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random-access memory (RAM) 1208 used as the main memory in the computing device 1200. The chipset 1206 may further provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems through local area network (LAN). The chipset 1206 may include functionality for providing network connectivity through a network interface controller (NIC) 1222, such as a gigabit Ethernet adapter. A NIC 1222 may be capable of connecting the computing device 1200 to other computing nodes over a network 1216. It should be appreciated that multiple NICs 1222 may be present in the computing device 1200, connecting the computing device to other types of networks and remote computer systems.

The computing device 1200 may be connected to a mass storage device 1228 that provides non-volatile storage for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. The mass storage device 1228 may comprise a management component 1210. A storage controller 1224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 may store data on the mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may further read information from the mass storage device 1228 by detecting the physical states or characteristics of one or more particular locations within the physical storage units.

In addition to the mass storage device 1228 described above, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 may have access to computer-readable storage media storing computer-executable instructions, which, when executed by the computing device 1200, may perform the methods described herein.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method for automatically generating video templates based on images using a machine learning model, comprising:
receiving at least one image by the machine learning model, wherein the machine learning model is trained to generate video templates based on input images, and wherein the video templates comprise editing components for generating or editing videos;
receiving a piece of music recommended based on the at least one image;
generating a conditional embedding by a first sub-model of the machine learning model based on a visual embedding indicative of the at least one image and a music embedding indicative of the piece of music; and
generating a representation of a video template based on the conditional embedding by a second sub-model of the machine learning model; and
generating the video template based on the representation of the video template, wherein the video template comprises a plurality of editing components corresponding to a plurality time slots, wherein the plurality of time slots covers different time ranges.

2. The method of claim 1, wherein the second sub-model of the machine learning model comprises a latent diffusion model.

3. The method of claim 1, further comprising:
training the machine learning model using pairs of training data, wherein each pair of training data comprises a particular video template and particular conditional information corresponding to the particular video template, and wherein the particular conditional information comprises visual information, music information, text information, and timing information comprised in the particular video template.

4. The method of claim 3, further comprising:
generating a representation of the particular video template that is encodable and decodable by the second sub-model of the machine learning model; and
generating a conditional embedding corresponding to the particular video template by inputting visual embedding indicative of the visual information, music embedding indicative of the music information, text embedding indicative of the text information, and time embedding indicative of the timing information into the first sub-model of the machine learning model.

5. The method of claim 4, wherein the generating a representation of the particular video template further comprises:
determining a plurality of groups of editing components corresponding to time slots of the particular video template;
generating a plurality of groups of editing component embeddings corresponding to the time slots of the particular video template; and
generating the representation of the particular video template by arranging the plurality of groups of editing component embeddings according to a sequence of the time slots.

6. The method of claim 1, further comprising:
receiving text input by a user; and
generating the conditional embedding by the first sub-model of the machine learning model based on the visual embedding indicative of the at least one image, the music embedding indicative of the piece of music, and a text embedding indicative of the text input by the user.

7. The method of claim 1, further comprising:
refining the plurality of editing components by performing spatial adjustments on at least a subset of the plurality of editing components.

8. The method of claim 1, further comprising:
refining the plurality of editing components by performing temporal alignments based on the piece of music.

9. The method of claim 1, further comprising:
generating a video using the video template, wherein the video comprises the at least one image, the piece of music, and the plurality of editing components applied in the different time ranges.

10. A system for automatically generating video templates based on images using a machine learning model, comprising:
at least one processor; and
at least one memory communicatively coupled to the at least one processor and comprising computer-readable instructions that upon execution by the at least one processor cause the at least one processor to perform operations comprising:
receiving at least one image by the machine learning model, wherein the machine learning model is trained to generate video templates based on input images, and wherein the video templates comprise editing components for generating or editing videos;
receiving a piece of music recommended based on the at least one image;
generating a conditional embedding by a first sub-model of the machine learning model based on a visual embedding indicative of the at least one image and a music embedding indicative of the piece of music; and
generating a representation of a video template based on the conditional embedding by a second sub-model of the machine learning model; and
generating the video template based on the representation of the video template, wherein the video template comprises a plurality of editing components corresponding to a plurality time slots, wherein the plurality of time slots covers different time ranges.

11. The system of claim 10, wherein the second sub-model of the machine learning model comprises a latent diffusion model.

12. The system of claim 10, the operations further comprising:
training the machine learning model using pairs of training data, wherein each pair of training data comprises a particular video template and particular conditional information corresponding to the particular video template, and wherein the particular conditional information comprises visual information, music information, text information, and timing information comprised in the particular video template.

13. The system of claim 12, further comprising:
generating a representation of the particular video template that is encodable and decodable by the second sub-model of the machine learning model; and
generating a conditional embedding corresponding to the particular video template by inputting visual embedding indicative of the visual information, music embedding indicative of the music information, text embedding indicative of the text information, and time embedding indicative of the timing information into the first sub-model of the machine learning model.

14. The system of claim 13, wherein the generating a representation of the particular video template further comprises:
determining a plurality of groups of editing components corresponding to time slots of the particular video template;
generating a plurality of groups of editing component embeddings corresponding to the time slots of the particular video template; and
generating the representation of the particular video template by arranging the plurality of groups of editing component embeddings according to a sequence of the time slots.

15. The system of claim 10, the operations further comprising:
receiving text input by a user; and
generating the conditional embedding by the first sub-model of the machine learning model based on the visual embedding indicative of the at least one image, the music embedding indicative of the piece of music, and a text embedding indicative of the text input by the user.

16. A non-transitory computer-readable storage medium, storing computer-readable instructions that upon execution by a processor cause the processor to implement operations comprising:
receiving at least one image by the machine learning model, wherein the machine learning model is trained to generate video templates based on input images, and wherein the video templates comprise editing components for generating or editing videos;
receiving a piece of music recommended based on the at least one image;
generating a conditional embedding by a first sub-model of the machine learning model based on a visual embedding indicative of the at least one image and a music embedding indicative of the piece of music; and
generating a representation of a video template based on the conditional embedding by a second sub-model of the machine learning model; and
generating the video template based on the representation of the video template, wherein the video template comprises a plurality of editing components corresponding to a plurality time slots, wherein the plurality of time slots covers different time ranges.

17. The non-transitory computer-readable storage medium of claim 16, wherein the second sub-model of the machine learning model comprises a latent diffusion model.

18. The non-transitory computer-readable storage medium of claim 16, the operations further comprising:
training the machine learning model using pairs of training data, wherein each pair of training data comprises a particular video template and particular conditional information corresponding to the particular video template, and wherein the particular conditional information comprises visual information, music information, text information, and timing information comprised in the particular video template.

19. The non-transitory computer-readable storage medium of claim 18, the operations further comprising:
generating a representation of the particular video template that is encodable and decodable by the second sub-model of the machine learning model; and
generating a conditional embedding corresponding to the particular video template by inputting visual embedding indicative of the visual information, music embedding indicative of the music information, text embedding indicative of the text information, and time embedding indicative of the timing information into the first sub-model of the machine learning model.

20. The non-transitory computer-readable storage medium of claim 19, wherein the generating a representation of the particular video template further comprises:
determining a plurality of groups of editing components corresponding to time slots of the particular video template;
generating a plurality of groups of editing component embeddings corresponding to the time slots of the particular video template; and
generating the representation of the particular video template by arranging the plurality of groups of editing component embeddings according to a sequence of the time slots.
